(19) United States
(12) Patent Application Publication
(10) Pub. No.: US 2005/0204025 A1
(43) Pub. Date: Sep. 15, 2005

(54) Telephony event management system and method in a communications network

(75) Inventor: Ziv Haparnas, San Francisco, CA (US)

Correspondence Address: FARSHAD JASON FARHADIAN;CENTURY IP LAW GROUP, P.O. BOX 7333, NEWPORT BEACH, CA, 92658-7333, US

(73) Assignee: IXI Mobile (R&D) Ltd.

(21) Appl. No.: 10/797,695

(22) Filed: Mar. 10, 2004

(51) Int. Cl. H04B 3/36

(52) U.S. Cl. 709/223; 709/203; 370/332

(57) ABSTRACT

A method of controlling events executed on a first device connected to a mobile communications network using a second device connected to the first device over a wired communications network is provided. The method comprises executing a first event by interacting with the second device; communicating data associated with the first event to the first device over the wired communications network; and executing a second event on the first device, wherein the second event corresponds to the first event executed on the second device.

### BACKGROUND

1. Field of Invention

The present invention relates generally to an event management system and method in a communications network and, more particularly, to managing telephony events directed to a first wireless device from a wireless communications network by way of a second device connected to the first device over a wired IP-based communications network.

### COPYRIGHT & TRADEMARK NOTICES

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

2. Related Art

Mobile communication devices such as cellular telephones and personal digital assistants (PDAs) are becoming more sophisticated and powerful. As a result, more users today utilize such devices to communicate or transact business. These devices, however, cannot yet fully compete with or provide the convenience and resources of a general-purpose computer.

Typically, general-purpose computers provide faster access to remote content (e.g., internet resources), a far more superior display and a more convenient user interface (e.g., full size keyboard) in comparison with a mobile wireless device. Further, general-purpose computers are better equipped in terms of storage and processing power to handle many resource-intensive computing tasks that a mobile wireless device is simply unable to carryout in an efficient manner. For these reasons, many users prefer to connect their mobile devices to a more powerful and convenient to use system, such as a desktop computer, when possible to take advantage of the additional resources.

Certain currently available mobile devices can be directly connected to a general purpose computer over a locally established wired or wireless connection either by way of a cable, infrared, Bluetooth or other communication interface. A local connection, typically, allows the user to directly transfer or synchronize information stored in one device with the other. To a local connection, both the general-purpose computer and the wireless device need to have their interface ports configured for communication over the local connection.

Most local connections established in the above manner, however, do not allow the user to control or view the events executed on the wireless device through the general-purpose computer attached to it, or vice versa. That is, the user cannot for example connect a mobile phone to a general-purpose computer such that a notification is displayed on the general-purpose computer when the mobile phone receives an incoming call.

Or, for example, a user cannot use the general-purpose computer to access or respond to a message received by the mobile wireless device, in real time. In other words, most of the currently available connection mechanisms provide nothing more than the capability of simple data transfer between the two devices.

A system and method is needed that can overcome the above shortcomings by providing a mechanism that allows telephony events on a wireless device to be directed to a selected second device over a pre-existing IP-based connection to circumvent the need for establishing a local connection between the two devices.

### SUMMARY

The present disclosure is directed to a telephony event management system and corresponding methods for controlling telephony events communicated to a mobile device over a wireless communications network, using a second device connected to the mobile device over a non-wireless communications network.

For the purpose of summarizing, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested.

In accordance with one aspect of the invention, a method of managing telephony events associated with a first device connected to a wireless communications network comprises monitoring data directed to the first device over the wireless communications network; determining if first data directed to the first device is associated with a first communication category, wherein the first data is configured to cause the first device to execute a first telephony event; and generating second data for communication to a second device over a wired communication connection, wherein the second data is configured to cause the second device to execute a second telephony event corresponding with the first telephony event.

In one embodiment, the method further comprises forwarding the second data to the second device over an internet protocol (IP) based connection, a transmission control protocol/Internet Protocol (TCP/IP) based connection, or a user datagram protocol/Internet Protocol (UDP/IP) based connection. In some embodiments, the second data is forwarded to the second device by way of a server device connecting the first device and the second device over a wired internet connection.

In some embodiments, the server device performs the step of generating the second data and the first communication category defines a set of executable telephony events. The set of executable telephony events comprises at least one of answering an incoming call, ignoring an incoming call, and disconnecting an incoming call.

In accordance with another embodiment, a method of controlling events executed on a first device connected to a mobile communications network using a second device connected to the first device over a wired communications network comprises executing a first event by interacting with the second device; communicating data associated with the first event to the first device over the wired communications network; and executing a second event on the first device, wherein the second event corresponds to the first event executed on the second device.

In one embodiment, the first event comprises composing a text message using resources of the second device. The second event comprises transmitting the text message over the mobile communications network to a destination. The wired communications network is an internet protocol (IP) based communication network, wherein the data associated with the first event is communicated to the first device over a transmission control protocol/Internet Protocol (TCP/IP) based connection, or over a user datagram protocol/Internet Protocol (UDP/IP) based connection.

In accordance with another embodiment, a system of controlling telephony events is provided the events are directed to a first device via a wireless communications network. The data associated with said telephony events is transferred to a second device connected to the first device by way of an internet protocol based network, wherein upon receipt of the data associated with the telephony events, the second device executes said telephony events.

In one embodiment, the second device can be used to control telephony events on the first device. The data associated with said telephony events is transferred over a transmission control protocol/Internet Protocol (TCP/IP) based connection, or over a over a user datagram protocol/Internet Protocol (UDP/IP) based connection.

These and other embodiments of the present invention will also become readily apparent to those skilled in the art from the following detailed description of the embodiments having reference to the attached figures, the invention not being limited to any particular embodiments disclosed.

### BRIEF DESCRIPTION OF THE DRAWINGS

Embodiments of the present invention are understood by referring to the figures in the attached drawings, as provided below.

FIG. 1 illustrates an exemplary communication environment in which a first device connected to a wireless communications network communicates with a second device by way of a wired communications network, in accordance with one embodiment of the invention;

FIG. 2 is flow diagram of a telephony event management method in accordance with one or more embodiments; and

FIGS. 3A and 3B are block diagrams of hardware and software environments in which a system of the present invention may operate, in accordance with one or more embodiments.

Features, elements, and aspects of the invention that are referenced by the same numerals in different figures represent the same, equivalent, or similar features, elements, or aspects, in accordance with one or more embodiments.

### DETAILED DESCRIPTION

A computing system and corresponding computer executable methods, according to an embodiment of the present invention, facilitate and provide a method for monitoring telephony events directed to a first device over a wireless communications network, and to selectively direct to a second device connected to the first device over a wired communications network, one or more of said telephony events.

Numerous specific details are set forth to provide a thorough description of various embodiments of the invention. Certain embodiments of the invention may be practiced without these specific details or with some variations in detail. In some instances, features not pertinent to the novelty of the system are described in less detail so as not to obscure other aspects of the invention.

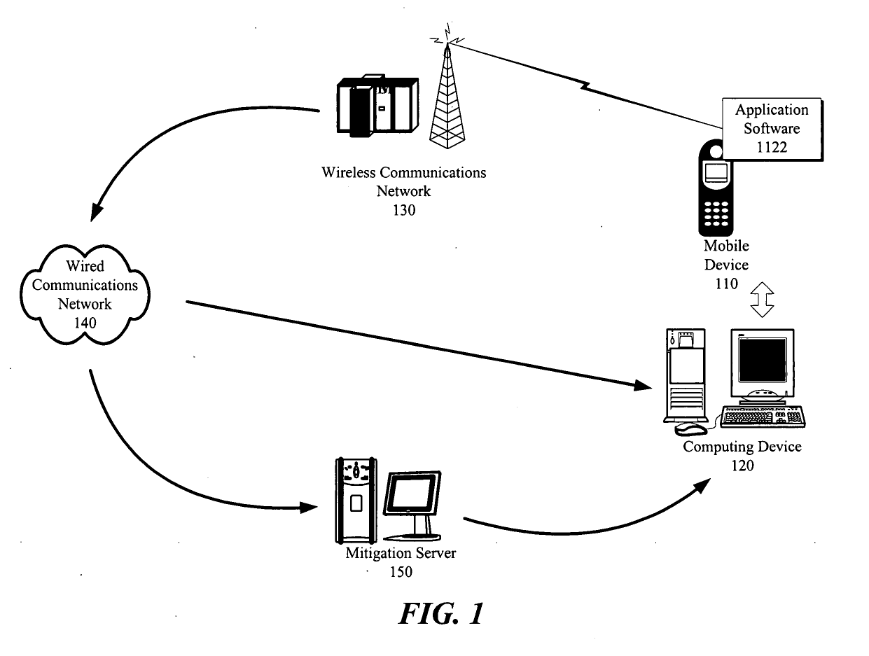

Referring to FIG. 1, in one or more embodiments of the present invention, a plurality of computing systems or devices (i.e., mobile device 110, computing device 120, etc.) may be arranged in wired and wireless communications networks to receive and transfer information. In alternative embodiments, certain devices may be connected either wirelessly or by wire in a non-networked environment to communicate data (i.e., by way of a data cable).

In one embodiment, mobile device 110 is connected to a wireless communications network 130. The wireless communications network 130 may be supported by a cellular service provider (e.g., Sprint, AT&T, Orange, etc.). Alternatively, the wireless communications network 130 may be established over wireless communications protocols, such as Bluetooth, IEEE 802.11, or other well-known wireless communications protocols. Wireless communications network 130, in one embodiment, is capable of communicating with wired communications network 140 that in turn is connected to computing device 120, either directly or indirectly, as provided in further detail below.

Mobile device 110, by way of example, may be one of a mobile computing device, a personal digital assistance, a cellular phone, or other wireless mobile device capable of communicating and connecting with wireless communications network 130. Computing device 120, by way of example, may be a laptop computer, a desktop computer or other general-purpose computing device capable of connecting and communicating with a wired communications network 140, such as the Internet, or any other Internet Protocol (IP) based communications network, for example.

One or more or a combination of wireless and wired communication technologies suited for connecting computing devices in short-range or long-range area networks and the like may be utilized, in certain embodiments, to connect mobile device 110 to computing device 120, for example. The terms “connected,” “coupled,” or any variant thereof, mean any connection or coupling, either direct or indirect, between two or more elements. The coupling or connection between the elements can be physical, logical, or a combination thereof.

One of ordinary skill in the art will appreciate that a communications network implemented according to the present invention may advantageously be comprised of various types of networks without detracting from the scope of the invention. Such networks, for example, can comprise local area networks (LANs), wide area networks (WANs), personal area network (PAN), public, private or secure networks, value-added networks, interactive television networks, two-way cable networks, satellite networks, interactive kiosk networks, cellular communications networks, personal mobile gateways (PMGs) and/or any other suitable communications network.

In certain embodiments, application software 1122 is executed on mobile device 110, for example, to monitor data communicated to mobile device 110 over wireless network 130. In certain embodiments, application software 1122 is dedicated to managing and monitoring telephony event related data such that certain telephony events directed for execution on mobile device 110 are also executed on computing device 120, as provided in further detail below.

In at least one embodiment, mobile device 110 is capable of communicating with a base station in wireless communications network 130 by way of a modem chipset utilizing communications technologies such as time division multiple access (TDMA), code division multiple access (CDMA), global systems for mobile communications (GSM), general packet radio service (GPRS), wideband CDMA (WCDMA) and other well-known wireless communications technologies. Mobile device 110 may also comprise a PMG device or communicate with a self-contained PMG device.

The PMG architecture comprises a PMG server that can wirelessly communicate with a number of PMG enabled devices within the personal area of the user or a PAN. A PAN is, typically, a close range wireless network in which multiple devices can communicate with one another as soon as a device is situated within the proximate range of another device. The devices in the PAN are generally equipped with low-cost, low-power, short-range radio communication interfaces, supported by well-known wireless communication protocols. A more detailed description of the PMG architecture is provided in U.S. patent application Ser. No. 09/850399, filed on May 7, 2001, the entire content of which is hereby incorporated by reference here.

As used herein, the terms mobile device, cellular phone and communications network are to be viewed as designations of one or more computing environments that comprise application, client or server software for servicing requests submitted by respective software applications included in devices or other computing systems connected thereto. These terms are not to be otherwise limiting in any manner. The application software 1122, for example, may be comprised of one or more modules that execute on one or more integrated or distributed computing environments, as provided in further detail below.

Referring back to FIG. 1, in accordance with one embodiment, application software 1122 is executed on mobile device 110. Application software 1122 may either directly communicate with computing device 120 over wired and wireless connections 140 and 130 respectively. Alternatively and depending on system implementation, application software 1122 may communicate with computing device 120 over wireless and wired connections 140 and 130 by way of a mitigation server 150.

The mitigation server 150, in one embodiment, acts as a gateway or a conduit system for routing data between mobile device 110 and computing device 120. As such, some of the data and command processing tasks may be performed by mitigation server 150, instead of a server in the wireless or wired networks 130 or 140. It is noteworthy that mitigation server 150 in addition can be a network server, a gateway server, a special purpose server, or a general purpose computing system, depending on implementation in one or more embodiments of the invention.

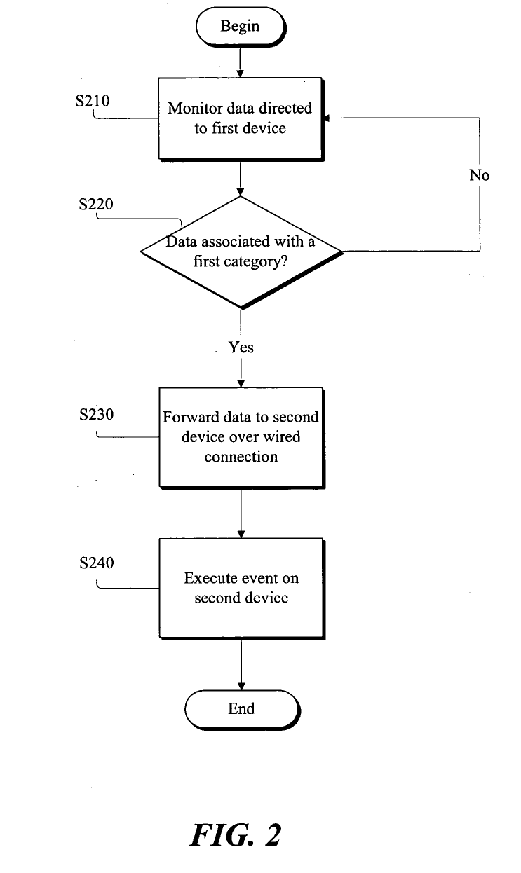

Referring to FIG. 2, in one embodiment, application software 1122 monitors data directed from wireless network 130 to mobile device 110 (S210). Data communicated to mobile device 110 may be, for example, data notifying mobile device 110 of an incoming call or message. Alternatively, the communicated data may include message content in form of text, voice, video or other media. As such, the data can be classified into various categories. For example, one category may be identified as “notification data,” while another category may be identified as “content data,” etc.

In one embodiment, application software 1122 monitors the data communicated to mobile device 110 to determine if the data is associated with or can be classified in a particular category (S220). If the communicated data is classified or associated with a particular category, then application software 1122 forwards the communicated data, or related data, to computing device 120 (S230), over wired or wireless networks 130 and 140. Otherwise, no data is forwarded from mobile device 110 to computing device 120.

In certain embodiments, application software 1122 is configured to forward the data to a destination address identifying computing device 120. The destination address is, for example, the IP address of computing device 120 in wired communications network 140 (e.g., an IP-based communications network). In other embodiments, the destination address is that of a mitigation server 150 which in turn forwards the data to computing device 120.

In response to receiving the data (or related data), computing device 120 executes one or more events (S240). The events executed by computing device 120, in one embodiment, are functionally equivalent to the events that are executed on mobile device 110 in response to receiving the data communicated from wireless communications network 130. For example, if mobile device 110 receives an incoming call, then application software 1122 causes data to be forwarded to computing device 120 so that when a ring tone is generated on mobile device 110, a ring tone is also generated on computing device 120.

In order to determine which data received from wireless communications network 130 by mobile device 110 is to be forwarded to computing device 120, application software 1122 identifies or classifies the data into one or more categories. That is, application software 1122 determines if the received data matches a predetermined data category and whether it is needed for the data or any related data to be directed to computing device 120. As such, in embodiments of the invention, various data categories are identified to distinguish data that is to be forwarded to computing device 120.

Therefore, for example, if application software 1122 identifies that the received data is audio data, then the audio data is not directed to computing device 120, since such data does not fall within a category of data identified for redirection to computing device 120 over an IP network. Otherwise, if it is determined that the received data is of a particular category (e.g., notification data), then the data is directed to computing device 120, by application software 1122.

In certain embodiments, secondary data (i.e., data related to the data received by mobile device 110) is directed to computing device 120. That is, mobile device 110 or an intervening device, such as mitigation server 150 or other server system in wireless network 130 or wired network 140 may determine that the received data should be converted prior to transmission to computing device 120. The conversion process in accordance to an embodiment of the invention is not limited to conversion of the received data from a first format to a second format but also may comprise generating related data (i.e., secondary data) that can be used by computing device 120 to produce the intended result.

Thus, for example, while the notification data received by mobile device 110 may be in form of an analog signal for a ring tone, the data directed to computing device 120 may be an audio file (e.g., a wave file) or a command to play a ring tone on computing device 120. In this manner, once the notification data for an incoming call is received by mobile device 110, a corresponding notification data for a ring tone is also forwarded to computing device 120. As such, a respective telephony event is executed on one or both of mobile device 110 and computing device 120 to produce similar results.

One skilled in the art will appreciate that telephony events and related data other than those described above may be identified within categories of events or data that are to be directed to computing device 120. As such, it should be noted that the above-disclosed embodiments are provided by way of example, are illustrative in nature, and should not be construed as limiting the scope of the invention to such particular embodiments.

In some embodiments, the monitoring, forwarding, and other functions discussed above in relation to application software 1122 are implemented in hardware, or a combination of hardware and software. As such, although application software 1122 is disclosed as applicable to the system of the present invention, this application is by way of example and shall not be construed to limit the scope of the invention to a software solution.

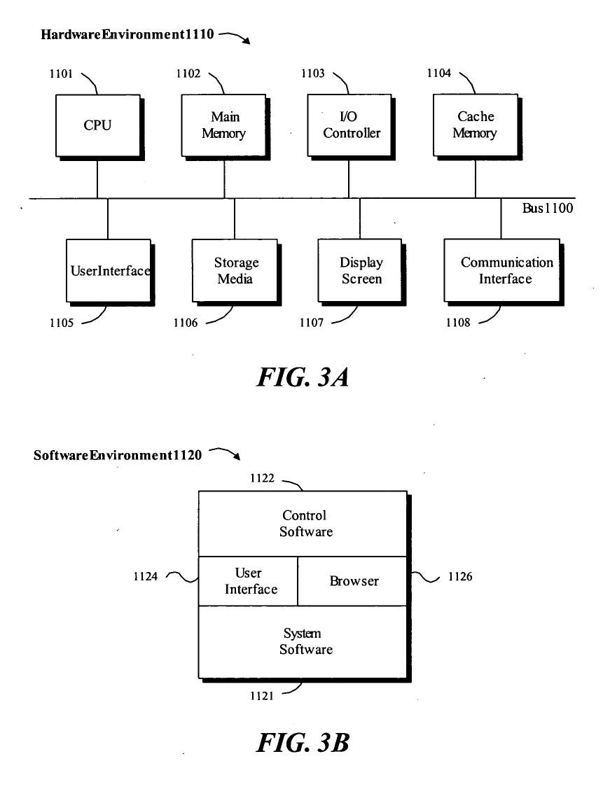

In embodiments of the system, mobile device 110 and computing device 120 comprise a controlled system environment that can be presented largely in terms of hardware components and software code executed to perform processes that achieve the results contemplated by the system of the present invention. A more detailed description of such system environment is provided below with reference to FIGS. 3A and 3B.

As shown, a computing system environment is composed of two environments, a hardware environment 1110 and a software environment 1120. The hardware environment 1110 comprises the machinery and equipment that provide an execution environment for the software. The software provides the execution instructions for the hardware. It should be noted that certain hardware and software components may be interchangeably implemented in either form, in accordance with different embodiments of the invention.

Software environment 1120 is divided into two major classes comprising system software 1121 and application software 1122. System software 1121 comprises control programs, such as the operating system (OS) and information management systems that instruct the hardware how to function and process information. Application software 1122 is a program that performs a specific task, such as monitoring data directed to mobile device 110. In certain embodiments of the invention, system and application software are implemented and executed on one or more hardware environments, for example.

Referring to FIG. 3A, an embodiment of the application software 1122 can be implemented as logic code in the form of computer readable code executed on a general purpose hardware environment 1110 that comprises a central processor unit (CPU) 1101, a main memory 1102, an input/output controller 1103, optional cache memory 1104, a user interface 1105 (e.g., keypad, pointing device, etc.), storage media 1106 (e.g., hard drive, memory, etc.), a display screen 1107, a communication interface 1108 (e.g., a wireless network card, a Blue tooth port, a wireless modem, etc.), and a system synchronizer (e.g., a clock, not shown in FIG. 3A).

Cache memory 1104 is utilized for storing frequently accessed information. A communication mechanism, such as a bi-directional data bus 1100, can be utilized to provide for means of communication between system components. Hardware Environment 1110 is capable of communicating with local or remote systems connected to a wireless communications network (e.g., a PAN or a WAN) through communication interface 1108.

In one or more embodiments, hardware environment 1110 may not include all the above components, or may include additional components for additional functionality or utility. For example, hardware environment 1110 can be a laptop computer or other portable computing device that can send messages and receive data through communication interface 1108. Hardware environment 1110 may also be embodied in an embedded system such as a set-top box, a personal data assistant (PDA), a wireless communication unit (e.g., cellular phone), or other similar hardware platforms that have information processing and/or data storage and communication capabilities. For example, in one or more embodiments of the system, hardware environment 1110 may comprise a PMG unit or an equivalent thereof.

In embodiments of the system, communication interface 1108 can send and receive electrical, electromagnetic, or optical signals that carry digital data streams representing various types of information including program code. If communication is established via a communications network, hardware environment 1110 may transmit program code through the network connection. The program code can be executed by central processor unit 1101 or stored in storage media 1106 or other non-volatile storage for later execution.

Program code may be transmitted via a carrier wave or may be embodied in any other form of computer program product. A computer program product comprises a medium configured to store or transport computer readable code or a medium in which computer readable code may be embedded. Some examples of computer program products are memory cards, CD-ROM disks, ROM cards, floppy disks, magnetic tapes, computer hard drives, and network server systems.

In one or more embodiments of the invention, processor 1101 is a microprocessor manufactured by Motorola, Intel, or Sun Microsystems Corporations, for example. The named processors are for the purpose of example only. Any other suitable microprocessor, microcontroller, or microcomputer may be utilized.

Referring to FIG. 3B, software 1120 or one or more of its components is stored in storage media 1106 and is loaded into memory 1102 prior to execution. Software environment 1120 comprises system software 1121 and application software 1122. Depending on system implementation, certain aspects of software environment 1120, and particularly application software 1122, can be loaded on one or more hardware environments 1110, or subcomponents thereof.

System software 1121 comprises software such as an operating system that controls the low-level operations of hardware environment 1110. Low-level operations comprise the management of the system resources such as memory allocation, file swapping, and other core computing tasks. In one or more embodiments of the invention, the operating system can be Nucleus, Microsoft Windows, Macintosh OS, or Linux. However, any other suitable operating system may be utilized.

Application software 1122 can comprise one or more computer programs that are executed on top of system software 1121 after being loaded from storage media 1106 into memory 1102. In a client-server architecture, application software 1122 may comprise client software and/or server software. Referring to FIG. 1, for example, in one embodiment of the invention, client software is executed on client device 110 and server software is executed on server device 120.

Software environment 1120 may also comprise web browser software 1126 for accessing content on a remote server. Further, software environment 1120 may comprise user interface software 1124 (e.g., a Graphical User Interface (GUI)) for receiving user commands and data. The received commands and data are processed by the software applications that run on the hardware environment 1110. The hardware and software architectures and environments described above are for purposes of example only. Embodiments of the invention may be implemented in any type of system architecture or processing environment.

Embodiments of the invention are described by way of example as applicable to systems and corresponding methods for managing power consumption in a battery operated device communicating in a wireless network environment. In this exemplary embodiment, logic code for performing these methods is implemented in the form of, for example, application software 1122. The logic code, in one embodiment, may be comprised of one or more modules that execute on one or more processors in a distributed or non-distributed communication model. For example, one or more embodiments of the present invention may comprise separate radio and baseband modules, or alternatively modules incorporating the radio, baseband, micro-controller and flash memory in a single-chip solution.

It should also be understood that the programs, modules, processes, methods, and the like, described herein are but exemplary implementations and are not related, or limited, to any particular computer, apparatus, or computer programming language. Rather, various types of general-purpose computing machines or customized devices may be used with logic code implemented in accordance with the teachings provided, herein. Further, the order in which the methods of the present invention are performed is purely illustrative in nature. These methods can be performed in any order or in parallel, unless indicated otherwise in the present disclosure.

The methods of the present invention may be performed in either hardware, software, or any combination thereof. In particular, some methods may be carried out by software, firmware, or macrocode operating on a single computer a plurality of computers. Furthermore, such software may be transmitted in the form of a computer signal embodied in a carrier wave, and through communication networks by way of Internet portals or websites, for example. Accordingly, the present invention is not limited to any particular platform, unless specifically stated otherwise in the present disclosure.

The present invention has been described above with reference to preferred embodiments. However, those skilled in the art will recognize that changes and modifications may be made in these preferred embodiments without departing from the scope of the present invention. Other system architectures, platforms, and implementations that can support various aspects of the invention may be utilized without departing from the essential characteristics as described herein. These and various other adaptations and combinations of features of the embodiments disclosed are within the scope of the invention. The invention is defined by the claims and their full scope of equivalents.

1. A method of managing telephony events associated with a first device connected to a wireless communications network, the method comprising:
monitoring data directed to the first device over the wireless communications network;
determining if first data directed to the first device is associated with a first communication category, wherein the first data is configured to cause the first device to execute a first telephony event; and
generating second data from the first data, for communicating the second data to a second device over a wired communication connection, wherein the second data is configured to cause the second device to execute a second telephony event corresponding with the first telephony event.

2. The method of claim 1, further comprising forwarding the second data to the second device.

3. The method of claim 2, further comprising forwarding the second data to the second device directly over an internet protocol (IP) based connection.

4. The method of claim 2, further comprising forwarding the second data to the second device directly over a transmission control protocol/Internet Protocol (TCP/IP) based connection.

5. The method of claim 2, further comprising forwarding the second data to the second device directly over a user datagram protocol/Internet Protocol (UDP/IP) based connection.

6. The method of claim 2, further comprising forwarding the second data to the second device by way of a server device connecting the first device and the second device over a wired internet connection.

7. The method of claim 6, wherein the server device performs the step of generating the second data.

8. The method of claim 1, wherein the first communication category defines a set of executable telephony events.

9. The method of claim 8, wherein the set of executable telephony events comprises at least one of answering an incoming call, ignoring an incoming call, and disconnecting an incoming call.

10. The method of claim 1 further comprising the second device executing the second event upon receiving the second data.

11. A method of controlling events executed on a first device connected to a mobile communications network using a second device connected to the first device over a wired communications network, the method comprising:
executing a first event by interacting with the second device;
communicating data associated with the first event to the first device over the wired communications network; and
executing a second event on the first device, wherein the second event corresponds to the first event executed on the second device.

12. The method of claim 11, wherein the first event comprises composing a text message using resources of the second device.

13. The method of claim 12, wherein the second event comprises transmitting the text message over the mobile communications network to a destination.

14. The method of claim 11, wherein the wired communications network is an internet protocol (IP) based communication network.

15. The method of claim 11, wherein the data associated with the first event is communicated to the first device over a transmission control protocol/Internet Protocol (TCP/IP) based connection.

16. The method of claim 11, wherein the data associated with the first event is communicated to the first device over a user datagram protocol/Internet Protocol (UDP/IP) based connection.

17. A system of controlling telephony events directed to a first device via a wireless communications network, by way of transferring data associated with said telephony events to a second device connected to the first device by way of an internet protocol based network, wherein upon receipt of the data associated with the telephony events, the second device executes said telephony events.

18. The system of claim 17, the second device can be used to control telephony events on the first device.

19. The system of claim 17, wherein the data associated with said telephony events is transferred over a transmission control protocol/Internet Protocol (TCP/IP) based connection.

20. The system of claim 17, wherein the data associated with said telephony events is transferred over a user datagram protocol/Internet Protocol (UDP/IP) based connection.
